(19) United States
(12) Patent Application Publication
(10) Pub. No.: US 2010/0188092 A1
(43) Pub. Date: Jul. 29, 2010

(54) Voltage-detection component and a substrate having the same

(75) Inventors: Masashi Sekizaki, Makinohara (JP); Kimihiro Matsuura, Makinohara (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 12/656,349

(22) Filed: Jan. 27, 2010

(30) Foreign Application Priority Data
Jan. 28, 2009 (JP) 2009-017072

(51) Int. Cl. G01N 27/416

(52) U.S. Cl. 324/427

(57) ABSTRACT

A substrate includes a plurality of voltage-detection components, each of which includes (a) an upper connecting terminal that protrudes from one of a pair of first sides opposite each other of a body of a voltage-detection component and is connected to an adjacent voltage-detection component of an adjacent higher-ordered battery block of the battery pack, and (b) a lower connecting terminal that protrudes from the other of the pair of the first sides of the body and is connected to an adjacent voltage-detection component of an adjacent lower-ordered battery block of the battery pack. The plurality of voltage-detection components are aligned on the substrate in a direction substantially orthogonal to the pair of the first sides of the body of the component.

### CROSS-REFERENCE TO RELATED APPLICATION

The Japan Patent Applications No. 2009-017072 and No. 2010-000953 upon which this patent application is based are incorporated by reference herein.

### BACKGROUND OF THE INVENTION

1. Field of the Invention

The present invention relates to a voltage-detection component and a substrate incorporating the same, and in particular to a voltage-detection component for a battery pack and a substrate incorporating a plurality of the voltage-detection components, each component being configured to detect on a per-block basis a voltage between both terminals of a unit cell, the battery pack including a plurality of battery blocks, the battery blocks of the battery pack each including more than one unit cell, the unit cells being secondary cells that are connected to each other to constitute the battery pack.

2. Description of the Related Art

A hybrid electric vehicle (HEV), which is powered simultaneously by a conventional internal combustion engine propulsion system and an electric propulsion system, has two batteries, i.e., a low-voltage battery in order of 12 volts for starting the conventional engine and a high-voltage battery for driving an electric motor. In order to obtain a high voltage, the high-voltage battery includes a plurality of unit cells series-connected to each other, the unit cell being a secondary cell such as a nickel-metal-hydride cell and a lithium cell.

The high-voltage battery, which may also be called a battery pack, includes a plurality of battery blocks, each block having a dedicated voltage-detection component (for example, see Japanese Patent Application Laid-Open Publication No. 2008-289234). Each voltage-detection component detects a voltage between both terminals of the unit cell that belongs to the block to which the component is dedicated, and the detected voltage is transmitted to a main microprocessor that controls the functionality and operation of the high-voltage battery. A lowest-ordered voltage-detection component is connected in series with a second lowest-ordered voltage-detection component, which likewise is connected in series with a third lowest-ordered voltage-detection component. The lowest-ordered component alone is connected via for example a photocoupler to the main microprocessor. Such configuration is intended for reducing lengths of wiring and the number of terminals.

Information that has been output by the main microprocessor is first transmitted to the lowest-ordered voltage-detection component. The information is then transferred from the lowest-ordered voltage-detection component to intermediately-ordered components, until it is finally received by a highest-ordered component.

Likewise, information originating from the highest-ordered voltage-detection component is passed on to the intermediately-ordered voltage-detection components. When the information has been received by the lowest-ordered voltage-detection component, the lowest-ordered component then transmits the information to the main microprocessor. In this manner, information originating from any of these voltage-detection components can be transmitted to the main microprocessor.

### SUMMARY OF THE INVENTION

When more than one voltage-detection components is incorporated on a substrate, arrangement of terminals of the voltage-detection components must be component-specific in accordance with the specific arrangement of each voltage-detection component. The terminal arrangement could cause communications failure due to increased length and complexity of wiring, and increased size of the substrate due to increased area occupied by extended and/or complicated wiring.

Accordingly, an object of the present invention is to provide a voltage-detection component and a substrate incorporating the same, which allows a plurality of the voltage-detection components to be series-connected via short connection lines, thereby improving reliability of communications and making the substrate more low-profile (i.e., reducing a size of the substrate).

In order to attain the above-identified object, there is provided a voltage-detection component for a battery block of a battery pack configured to detect a voltage between both terminals of a unit cell that belongs to the battery block. The battery blocks include at least one of unit cells that are connected in series with each other to constitute the battery pack, the unit cells being secondary cells.

The voltage-detection component includes (a) a body having a pair of first sides opposite each other; (b) an upper connecting terminal protruding from one of the first sides of the body and connected to a voltage-detection component of an adjacent higher-ordered battery block of the battery pack; and (c) a lower connecting terminal protruding from an other of the first sides of the body and connected to a voltage-detection component of an adjacent lower-ordered battery block of the battery pack.

Since the upper connecting terminal is provided on one of the first sides of the body of the voltage-detection component and the lower connecting terminal on the other of the first sides thereof opposite the one of the first sides, a plurality of the voltage-detection components that are aligned upon the substrate can be connected in series with each other with reduced wiring lengths, making it possible to ensure more reliable communications and allow the substrate to be more low-profile.

Preferably, the voltage-detection component further includes (d) a cell-connecting terminal configured to connect the voltage-detection component to the connector to which voltages between both ends of the unit cells are input, the cell-connecting terminal protruding from one of a pair of second sides of the body opposite each other and between the pair of the first sides of the body, and (e) a peripheral-component-connecting terminal configured to connect the voltage-detection component to a peripheral component, the peripheral-component-connecting terminal protruding from an other of the pair of the second sides of the body.

Since the cell-connecting terminal is provided on the one of the pair of the second sides of the body of the voltage-detection component and the peripheral-component-connecting terminal is provided on the other of the second sides of the body thereof, it is possible to allow for distance between the cell-connecting terminal and the peripheral-component-connecting terminal so that it is possible to prevent adverse effect upon the peripheral component, such as electromagnetic interference caused by the battery pack.

In another aspect, there is provided a substrate incorporating a plurality of the above-described voltage-detection components that are aligned in a direction orthogonal to the pairs of the first sides of the bodies.

Since the voltage-detection components are closely aligned with respect to each other in the direction orthogonal to the pairs of the first sides of the bodies of the voltage-detection components, the voltage-detection components can be connected in series with each other with reduced wiring lengths, and thus the communications can be made more reliable and the substrate more low-profile.

In yet another aspect, there is provided a substrate comprising a plurality of the above-described voltage-detection components that are aligned in a direction orthogonal to the pairs of the first sides of the bodies, the connector being arranged adjacent to respective ones of the pairs of the second sides from which the cell-connecting terminal protrudes, and a plurality of the peripheral components being arranged adjacent to the respective others of the pairs of the second sides from which the peripheral-component-connecting terminal protrudes.

Since the voltage-detection components are closely aligned with respect to each other in the direction orthogonal to the pairs of the first sides of the bodies of the voltage-detection components, the voltage-detection components can be connected in series with each other with reduced wiring lengths. Also, since the connector is arranged adjacent to respective ones of the pairs of the second sides and the peripheral components are arranged adjacent to the respective others of the pairs of the second sides, it is possible to connect the connector to the cell-connecting terminal and the peripheral components to the peripheral-component-connecting terminal with reduced wiring lengths. Further, since wiring for connection of the voltage-detection components to the connector can be separated from wiring for connection of the voltage-detection components to the peripheral components, it is possible to prevent deterioration of functionality and performance, ensure reliable communications, and make the substrate more low-profile.

### BRIEF DESCRIPTION OF THE DRAWINGS

The above and other objects and advantages of the present invention will be apparent upon reading of the following detailed description, taken in conjunction with the following accompanying drawings, in which like reference numerals represent corresponding parts throughout:

FIG. 1 is a circuit diagram of a voltage detection system incorporating the voltage-detection components according to one embodiment of the present invention.

FIG. 2 is a circuit diagram of the voltage-detection component of FIG. 1.

FIG. 3 is a top view of the voltage-detection component of FIG. 1.

FIG. 4 is a top view of the substrate incorporating the voltage-detection components of FIG. 3.

### DETAILED DESCRIPTION OF THE PREFERRED EMBODIMENT

A voltage detection system according to one embodiment of the present invention is intended for, but not limited to, use in an automobile or other vehicle.

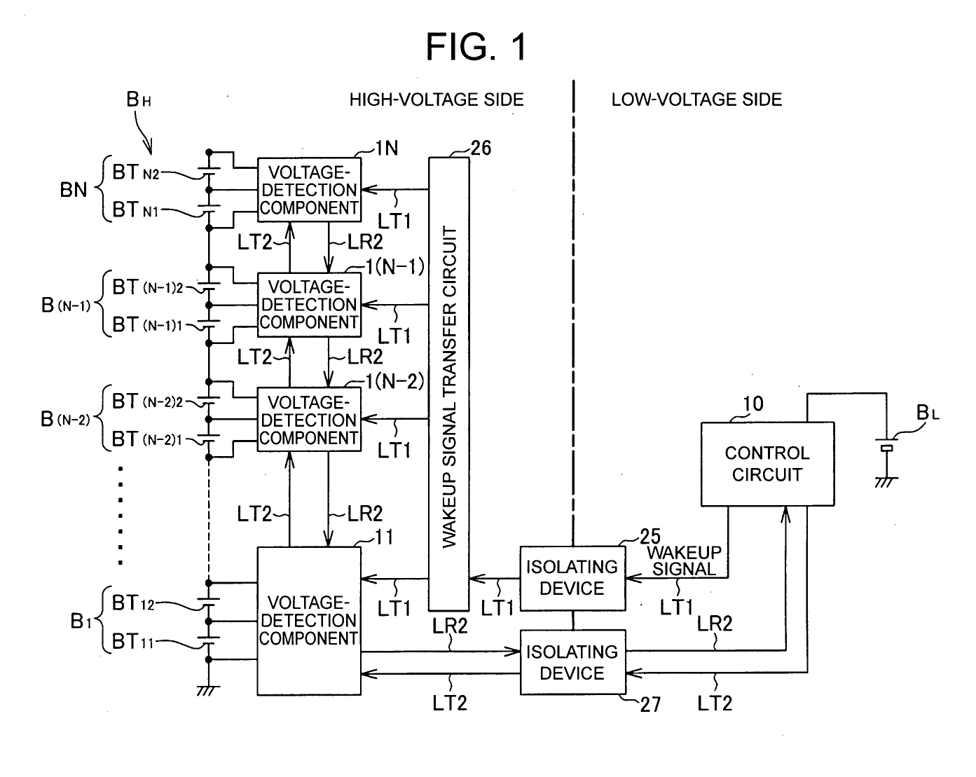

Referring to FIG. 1, there is shown the voltage detection system that includes a high-voltage system that includes a plurality of voltage-detection components and a low-voltage system that includes a low-voltage battery BL and a control circuit 10.

The low-voltage battery BL includes a plurality of secondary cells. The low-voltage battery BL is used to drive a starter that starts an engine of a hybrid electric vehicle (HEV). Components such as an alternator (not shown) may be connected as required to an end of the low-voltage battery BL.

A high-voltage battery BH, which is a battery pack, serves as a power source for an electric motor of the HEV vehicle powered by the electric motor and an internal combustion engine. The electric motor is connected to an end of the high-voltage battery BH, and components such as an alternator (not shown) may be connected as a battery charger to the end of the high-voltage battery BH.

The high-voltage battery BH comprises N battery blocks B1 to BN (N represents an integer equal to or greater than two). The battery blocks B1 to BN may include more than one (two in the figures) unit cells BT11 and BT12 to BTN1 and BTN2, respectively. Unit cells BT11 to BTN2 may each consist of one secondary cell.

The voltage detection system according to one embodiment of the present invention includes a control circuit 10 on the side of a low-voltage system and voltage-detection components 11 to 1N (N represents an integer equal to or greater than two). The low-voltage-system control circuit 10 may be a microprocessor. The low-voltage-system control circuit 10, which is powered by the low-voltage battery BL, controls the voltage-detection components 11 to 1N.

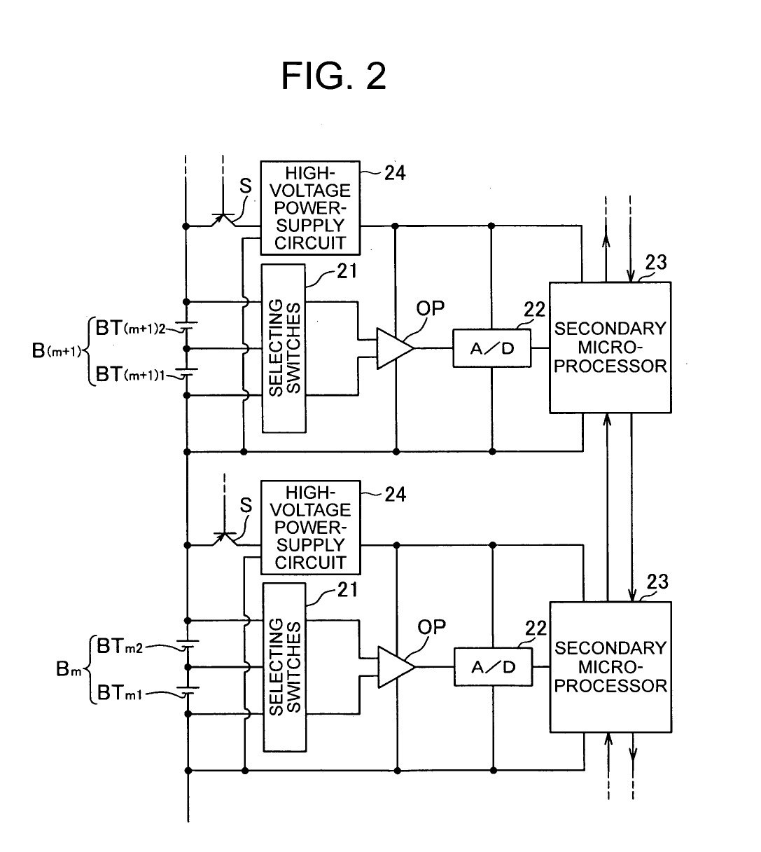

The voltage-detection components 11 to 1N are each dedicated to the battery blocks B1 to BN. As shown in FIG. 2, the voltage-detection components 11 to 1N are only powered by the corresponding unit cells BT11 to BTN2 of the battery blocks B1 to BN to which the voltage-detection components 11 to 1N are dedicated on a per-block basis. Circuits of the voltage detection components 11 to 1N each may have different ground levels of voltage on negative sides of the battery blocks B1 to BN, which allows withstand voltage of the devices of the voltage detection circuits 11 to 1N to be lowered.

The voltage-detection components 11 to 1N may each have selecting switches 21, a differential amplifier OP, an analog-to-digital converter 22, a secondary microprocessor 23, a high-voltage-system power-supply circuit 24, and a shutdown switch S.

The selecting switches 21 are normally closed switches each connected to both terminals of the unit cells BT11 to BTN2 to connect one end of the unit cells BT11 to BTN2 to the differential amplifier OP.

The differential amplifier OP outputs a voltage between both terminals of the unit cell BT11 to BTN2 connected by the selecting switches 21 and transmits the voltage to the analog-to-digital converter 22.

The analog-to-digital converter 22 performs analog-to-digital conversion of the voltage between both ends of the unit cell BT11 to BTN2 that has been output by the differential amplifier OP and the A/D-converted signal is output to the secondary microprocessor 23.

The secondary microprocessor 23 includes a conventional CPU, a ROM unit, and a RAM unit, and controls operation of the voltage-detection component 11 to 1N.

The high-voltage-system power-supply circuit 24 generates, on the basis of a supply voltage of the corresponding battery block B1 to BN, an operating voltage for the differential amplifier OP, the analog-to-digital converter 22, and the secondary microprocessor 23.

The shutdown switch S is provided between the positive terminal of the battery blocks B1 to BN and the high-voltage-system power-supply circuit 24. The shutdown switch S is configured to turn on and off the voltage between both ends of the battery blocks B1 to BN supplied to the high-voltage-system power-supply circuit 24, so that power supply to the voltage-detection component 11 to 1N is switched on and off. The shutdown switch S is configured for example as a PNP transistor.

Also, the voltage-detection system as shown in FIG. 1 includes a transmission line LT1, an isolating device 25, and a wake-up signal transfer circuit 26. By virtue of these components, the shutdown switch S can be turned on in response to a wake-up signal output by the low-voltage-system control circuit 10. More specifically, the transmission line LT1 is provided between a base of the PNP transistor configuring each of the shutdown switches S and the low-voltage-system control circuit 10. An end of the transmission line LT1 is connected to the low-voltage-system control circuit 10, while the other end thereof branches to be connected to the base of the shutdown switch S of the voltage-detection component 11 to 1N.

The isolating device 25 is provided on the transmission line LT1 and connects the shutdown switch S and the low-voltage-system control circuit 10 while isolating these two parts. This allows electrical isolation of the high-voltage battery BH from the low-voltage battery BL. The isolating device 25 may be a known photocoupler including a light emitting device and a light-receiving element or a magnetic coupler. The wake-up signal transfer circuit 26 is provided on the transmission line LT1 and is configured to convert an wake-up signal transmitted from the low-voltage-system control circuit 10 into a signal having a level appropriate for turning on and off the shutdown switch S.

Also, the voltage detection system includes, as shown in FIG. 1, a transmission line LT2, a reception line LR2, and an isolating device 27, which enables communication between the low-voltage-system control circuit 10 and the voltage-detection components 11 to 1N. More specifically, the transmission line LT2 and the reception line LR2 are configured such that the voltage-detection components 11 to 1N are connected in series with each other. Since the ground level of voltage is specific to each of the voltage-detection components, the transmission line LT2 and the reception line LR2 that are provided between the voltage-detection components has to include a level-shift circuit (not shown).

Also, the transmission line LT2 and the reception line LR2 are configured such that, out of the voltage-detection components 11 to 1N, the lowest-ordered voltage-detection component 11 alone is connected to the low-voltage-system control circuit 10 via these lines. Restated, the transmission line LT2 and the reception line LR2 are provided such that the low-voltage-system control circuit 10, voltage-detection component 11, the voltage-detection component 12, and through to the voltage-detection component 1N are connected in series with each other in that order.

The isolating device 27 is provided on the transmission line LT2 and the reception line LR2 that extend between a lowest-ordered voltage-detection component 11 and the low-voltage-system control circuit 10 so that the voltage-detection components 11 to 1N are electrically isolated from but connected to the low-voltage-system control circuit 10. The lowest-ordered voltage-detection component 11 and the low-voltage-system control circuit 10 can transmit information to and receive information from each other while being isolated from each other by the isolating device 27. The isolating device 27 may be configured as a photocoupler including a light emitting device and a light-receiving element, or a magnetic coupler.

The above-described configuration allows the information that has been transmitted from the low-voltage-system control circuit 10, such as information on an instruction to detect voltage, to be first transmitted to the lowest-ordered voltage-detection component 11. After that, the lowest-ordered voltage-detection component 11 transmits the information to a next lowest-ordered one, and the next lowest-ordered one in turn transmits the information to its neighboring intermediately-ordered one, and likewise the intermediately-ordered one to a higher-ordered one in a daisy-chain manner, so that the information transmitted by the low-voltage-system control circuit 10 can be received by all the voltage-detection components 11 to 1N. Meanwhile, information transmitted by any, one of the voltage-detection components 1m is transmitted in a daisy-chain manner to lower-ordered ones. When the information has reached the lowest-ordered voltage-detection component 11, then the lowest-ordered voltage-detection component 11 transmits the information to the low-voltage-system control circuit 10. Thus, information originating from any one of the voltage-detection components 11 to 1N can be transmitted to the low-voltage-system control circuit 10.

It should be noted that, in the context of this document, the term “order” as in “lowest-ordered,” intermediately-ordered,” and highest-ordered” is used for convenience of explanation, only representing an order of appearance of a specific voltage-detection component within a sequence of the voltage-detection components that are series-connected to each other.

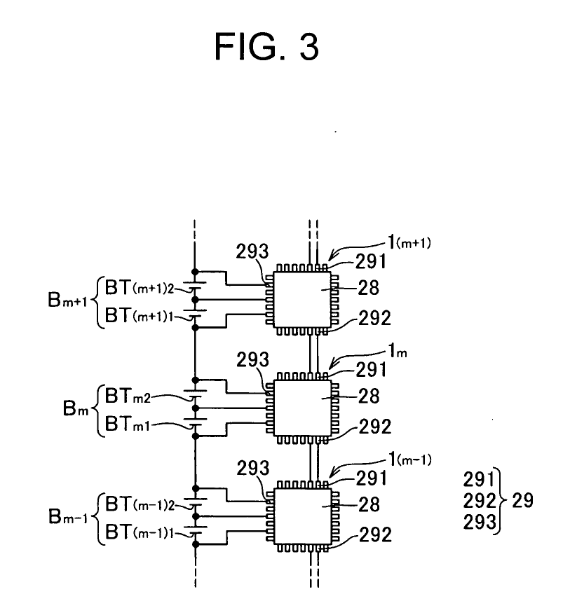

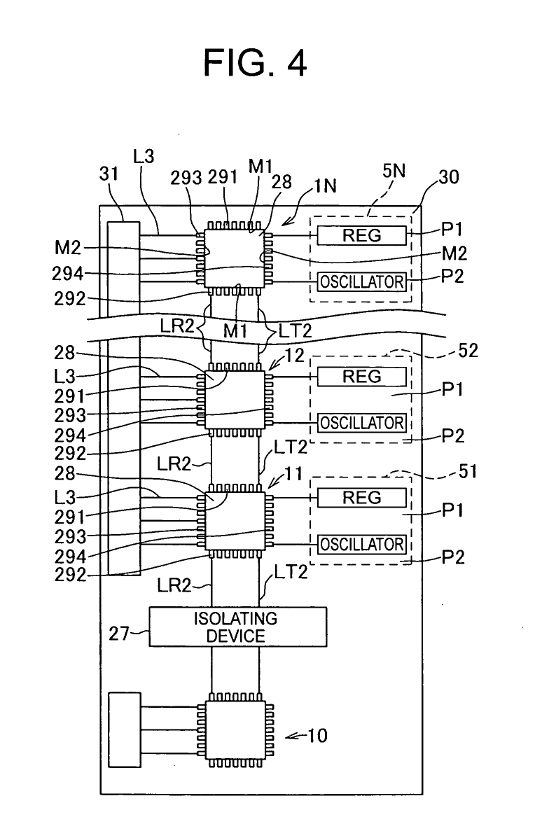

The following describes the configuration of the voltage-detection components 11 to 1N with reference to FIGS. 3 and 4.

As shown in FIGS. 3 and 4, the voltage-detection components 11 to 1N each include a body 28 and terminals 29. The body 28 is a semiconductor package incorporating electric components that have been described in the foregoing with reference to FIG. 2, i.e., the selecting switches 21, the differential amplifier OP, the secondary microprocessor 23, the high-voltage-system power-supply circuit 24, and the shutdown switch S, which constitute the voltage-detection component 11 to 1N. The terminals 29 may include an upper connecting terminal 291, a lower connecting terminal 292, a cell-connecting terminal 293, and a peripheral-component-connecting terminal 294.

The upper connecting terminal 291 is a terminal used to connect the voltage-detection components 11 to 1N to an adjacent higher-ordered one of the voltage-detection components 11 to 1N of the battery block B1 to BN. The upper connecting terminal 291 protrudes from one of a pair of first sides M1 of the body 28 in a shape of a rectangle in plan view. The lower connecting terminal 292 is used to connect the voltage-detection component to an adjacent lower-ordered one of the voltage-detection components 11 to 1N of the battery blocks B1 to BN. The lower connecting terminal 292 protrudes from the other of the pair of the first sides M1 of the body 28 parallel to and opposite the one of the pair of the first sides M1. The upper connecting terminal 291 and the lower connecting terminal 292 are electrically connected to the transmission line LT2 and the reception line LR2 printed on the substrate 30 (to be later described) so that the voltage-detection components 11 to 1N are connected in series with each other.

The cell-connecting terminal 293 is a terminal used to connect the voltage-detection components 11 to 1N to the high-voltage battery BH. The cell-connecting terminal 293 protrudes from one of a pair of second sides M2 which are opposite each other and between the pair of the first sides M1 of the body 28. The cell-connecting terminal 293 is electrically connected to a wiring pattern L3 printed on the substrate 30 so that the cell-connecting terminal 293 is connected to a connector 31 provided on the substrate 30. Accordingly, the high-voltage battery BH is connected via the connector 31 to the voltage-detection components 11 to 1N.

The peripheral-component-connecting terminal 294 is a terminal used to connect the voltage-detection components 11 to 1N to corresponding each of peripheral components (peripheral circuits) 51 to 5N. The peripheral components 51 to 5N may include a regulator (REG) P1 and an oscillator P2. The peripheral-component-connecting terminal 294 protrudes from the other of the second sides M2 opposite each other and between the pair of the first sides M1 where the upper connecting terminal 291 and the lower connecting terminal 292 protrude, respectively. The peripheral-component-connecting terminal 294 is electrically connected to a wiring pattern L5 printed on a substrate 30 (to be later described) and thereby the peripheral-component-connecting terminal 294 is connected to corresponding one of the peripheral components 51 to 5N provided on the substrate 30.

As shown in FIG. 4, the voltage-detection components 11 to 1N are aligned on the substrate 30 in a direction substantially orthogonal to the pair of the first sides of the body 28 where the upper connecting terminal 291 and the lower connecting terminal 292 protrude, respectively. The lower connecting terminal 292 of the voltage-detection component 1m corresponding to the battery block Bm faces the upper connecting terminal 291 of the voltage-detection component 1(m−1) corresponding to the lower block B(m−1) which is adjacent to the battery block Bm.

The connector 31 is provided on the substrate 30 such that the connector 31 is on the sides of the voltage-detection components 11 to 1N where the cell-connecting terminals 293 protrude. The peripheral components 51 to 5N are each arranged on the substrate 30 such that the peripheral components 51 to 5N are on the sides of the corresponding voltage-detection components 11 to 1N where the peripheral-component-connecting terminals 294 protrude.

Since the voltage-detection component 11 to 1N include the upper connecting terminals 291 on the one of the pair of the first sides M1 of the body 28 and the lower connecting terminal 292 on the other of the pair of the first sides M1 of the body 28 opposite the one of the pair of the first sides M1, it is possible to align the voltage-detection components 11 to 1N on the substrate 30 in the direction orthogonal to the pair of the first sides where the upper connecting terminal 291 and the lower connecting terminal 292 protrude, respectively. This arrangement of the voltage-detection component 11 to 1N allows the transmission line LT2 and the reception line LR2 to extend in a linear fashion and to connect the voltage-detection component 11 to 1N in series with each other via the transmission line LT2 having a reduced length and the reception line LR2 having a reduced length, so that the communication can be made more reliable and the substrate 30 can be made more low-profile (i.e., the size of the substrate 30 can be reduced).

Also, since the voltage-detection component 11 to 1N include the cell-connecting terminal 293 provided on the one of the pair of the second sides M2 of the body 28 of the voltage-detection component and the peripheral-component-connecting terminal 294 provided on the other of the second sides M2 of the body thereof, it is possible to allow for distance between the cell-connecting terminal 293 and the peripheral-component-connecting terminal 294 so that it is possible to prevent adverse effect upon the peripheral components 51 to 5N, such as electromagnetic interference caused by the high-voltage battery BH.

Also, in the substrate 30 incorporating the voltage-detection components 11 to 1N, the plurality of voltage-detection components 11 to 1N can be aligned in the direction orthogonal to the pair of the first sides of the body 28 where the upper connecting terminal 291 and the lower connecting terminal 292 protrude, respectively, and thus the voltage-detection components 11 to 1N can be connected in series with each other via the transmission line LT2 having the reduced length and the reception line LR2 having the reduced length, so that the communication can be made more reliable and the size of the substrate 30 can be reduced.

Further, in the substrate 30 incorporating the voltage-detection components 11 to 1N, since the connector 31 is arranged adjacent to respective ones of the pairs of the second sides M2 and the peripheral components 51 to 5N are arranged adjacent to the respective others of the pairs of the second sides M2, it is possible to connect the connector 31 to the cell-connecting terminal 293 and the peripheral components 51 to 5N to the peripheral-component-connecting terminal 294 using the wiring patterns L3, L4 having reduced wiring lengths.

Further, since wiring for connection of the voltage-detection components 11 to 1N to the connector 31 can be separated from wiring for connection of the voltage-detection components 11 to 1N to the peripheral components 51 to 5N, it is possible to prevent deterioration of functionality and performance, ensure reliable communications, and make the substrate 30 more low-profile.

Although, in the above-described embodiment, the voltage-detection components 11 to 1N share the same terminal arrangement, the present invention may be effected based on terminal arrangement other than that. For example, the lowest-ordered voltage-detection component 11 may take terminal arrangement different from the other ones, depending upon the location of the low-voltage-system control circuit 10 on the substrate 30.

While the invention has been described in terms of specific embodiments, it will be understood by those skilled in the art that various modifications may be made therein without departing from the spirit and scope of the invention. Also, the terms and expressions which have been employed in this specification are used for description and not for limitation, there being no intention in the use of such terms and expressions of excluding equivalents of the features shown and described or portions thereof. Accordingly, the scope of this invention is only defined and limited by the following claims and their equivalents.

What is claimed is:

1. A voltage-detection component for each of battery blocks of a battery pack, configured to detect a voltage between both terminals of a unit cell that belongs to the battery block, the battery block including at least one of unit cells, the unit cells being connected in series with each other to constitute the battery pack, the unit cells being secondary cells, and the voltage-detection component comprising:
(a) a body having a pair of first sides opposite each other;
(b) a upper connecting terminal protruding from one of the first sides of the body and connected to a voltage-detection component of an adjacent higher-ordered battery block of the battery pack; and
(c) a lower connecting terminal protruding from an other of the first sides of the body and connected to a voltage-detection component of an adjacent lower-ordered battery block of the battery pack.

2. The voltage-detection component according to claim 1, further comprising:
(d) a cell-connecting terminal configured to connect the voltage-detection component to the connector to which voltages between both ends of the unit cells are input, the cell-connecting terminal protruding from one of a pair of second sides of the body opposite each other and between the pair of the first sides of the body; and
(e) a peripheral-component-connecting terminal configured to connect the voltage-detection component to a peripheral component, the peripheral-component-connecting terminal protruding from an other of the pair of the second sides of the body.

3. A substrate comprising a plurality of the voltage-detection components of claim 2, the voltage-detection components being aligned in a direction orthogonal to the pairs of the first sides of the bodies.

4. A substrate comprising a plurality of the voltage-detection components of claim 2, wherein the voltage-detection components are aligned in a direction orthogonal to the pairs of the first sides of the bodies, the connector being arranged adjacent to respective ones of the pairs of the second sides from which the cell-connecting terminal protrudes, and a plurality of the peripheral components being arranged adjacent to the respective others of the pairs of the second sides from which the peripheral-component-connecting terminal protrudes.
